(19) United States
(12) Patent Application Publication
(10) Pub. No.: US 2022/0261620 A1
(43) Pub. Date: Aug. 18, 2022

(54) Distributed Processing System and Distributed Processing Method

(71) Applicant: Nippon Telegraph and Telephone Corporation, Tokyo (JP)

(72) Inventors: Kenji Kawai, Tokyo (JP); Junichi Kato, Tokyo (JP); Huycu Ngo, Tokyo (JP); Yuki Arikawa, Tokyo (JP); Tsuyoshi lto, Tokyo (JP); Takeshi Sakamoto, Tokyo (JP)

(21) Appl. No.: 17/596,070

(22) PCT Filed: Jun. 3, 2019
(86) PCT No.: PCT/JP2019/021943

§ 371 Date: Dec. 2, 2021

(51) Int. Cl. G06N 3/063; G06N 3/08

(52) U.S. Cl. CPC G06N 3/063; G06N 3/08

(57) ABSTRACT

A distributed processing node transmits distributed data for M groups as intermediate consolidated data from M communication units to a distributed processing node. A distributed processing node generates, for each group, updated intermediate consolidated data from the received intermediate consolidated data and distributed data, and transmits the updated intermediate consolidated data from the M communication units to a distributed processing node. The distributed processing node transmits the received intermediate consolidated data to a distributed processing node as consolidated data. The distributed processing node transmits the received consolidated data to a distributed processing node. Each of the distributed processing nodes updates weights of a neural network, based on the consolidated data.

### CROSS-REFERENCE TO RELATED APPLICATION

This application is a national phase entry of PCT Application No. PCT/JP2019/021943, filed on Jun. 3, 2019, which application is hereby incorporated herein by reference.

### TECHNICAL FIELD

The present disclosure relates to a distributed processing system including a plurality of distributed processing nodes, and particularly relates to a distributed processing system and a distributed processing method for consolidating numerical data from each of the distributed processing nodes to generate consolidated data, and distributing the consolidated data to each of the distributed processing nodes.

### BACKGROUND

In deep learning, the accuracy of inference is improved by updating a weight of each neuron model (a coefficient multiplied by a value output by a neuron model at a previous stage) on the basis of input sample data for a learning target constituted by a multi-layered neuron model.

A mini batch method is typically used for a method of improving the accuracy of inference. In a mini batch method, a gradient calculation process of calculating a gradient with respect to the weight for each piece of sample data, a consolidation process of consolidating the gradient for a plurality of different pieces of sample data (summing up the gradients, obtained for each piece of sample data, for each weight), and a weight updating process of updating each weight on the basis of the consolidated gradient are repeated.

These processes, particularly the gradient calculation process, require many iterated computations, but there is a problem in that a time required for deep learning increases as the number of weights and the number of pieces of input sample data increase in order to improve the accuracy of inference.

In order to increase the speed of the gradient calculation process, a distributed processing method is used. Specifically, a plurality of distributed processing nodes are provided, and each of the nodes performs a gradient calculation process for each of different pieces of sample data. As a result, as the number of pieces of sample data that can be processed per unit time can be increased in proportion to the number of nodes, the speed of the gradient calculation process can be increased (see NPL 1).

In a consolidation process in distributed processing for deep learning, it is required that communication (aggregation communication) for transferring data (distributed data) calculated at each of the distributed processing nodes to a node which performs a consolidation process, a consolidation process (inter-node consolidation process) based on data acquired through the aggregation communication, and communication (dispatch communication) for distributing, to each of the distributed processing nodes, the data (consolidated data) obtained by consolidating the data acquired from the distributed processing nodes, are performed between a gradient calculation process of calculating a gradient with respect to the weight for each piece of sample data as well as an in-node consolidation process of summing up the gradients, obtained for each piece of sample data, for each weight, and a weight updating process of updating each weight on the basis of the consolidated gradient, by each of the distributed processing nodes.

Requiring times for the above-described aggregation communication and dispatch communication, which are not required in a system that performs deep learning in a single node, results in a reduction in a processing speed in performing distributed processing of deep learning. In recent years, deep learning has been applied to more complicated problems, and a total number of weights tends to increase. Thus, the amount of distributed data and the amount of the consolidated data have increased, and an aggregation communication time and a dispatch communication time have increased.

As described above, a distributed processing system for deep learning has a problem that the effect of increasing the speed of deep learning is reduced due to, because of an increase in the number of distributed processing nodes, increases in the aggregation communication time and the dispatch communication time.

FIG. 13 shows a relationship between the number of distributed processing nodes and processing performance of deep learning in the distributed processing system of the related art, reference numeral 200 denotes an ideal relationship between the number of distributed processing nodes and processing performance (performance∝the number of nodes), and reference numeral 201 denotes an actual relationship between the number of distributed processing nodes and processing performance. The total amount of distributed data, which is an input of the inter-node consolidation process, is increased in proportion to the number of distributed processing nodes, but the actual processing performance does not improve in proportion to the number of distributed processing nodes. This is because the communication speed of the consolidation processing node is limited to equal to or less than the physical speed of the communication port of the node, and thus the time required for the aggregation communication increases.

### CITATION LIST

### Non Patent Literature

NPL 1: Akiba Takuya, “Distributed Deep Learning Package ChainerMN Release,” Preferred Infrastructure, 2017, Internet <https://research.preferred.jp/2017/05/chainermn-beta-release/>

### SUMMARY

### Technical Problem

The present disclosure takes into consideration the above-described situations, and an object of some aspects of the disclosure is to provide a distributed processing system and a distributed processing method which can perform an effective distributed process when being applied to deep learning in a distributed processing system that includes a plurality of distributed processing nodes.

### Means for Solving the Problem

A distributed processing system according to the present disclosure includes N (N being an integer equal to or greater than 2) distributed processing nodes arranged in a ring shape, each of the N distributed processing nodes being connected to an adjacent node via a communication path, in which an n-th (n=1, . . . , N) distributed processing node of the N distributed processing nodes including M (M being an integer equal to or greater than 2) communication units capable of simultaneous communication in both directions with an n⁺-th (n⁺=n+1, provided that n⁺=1 if n=N) distributed processing node of the N distributed processing nodes and an n³¹ -th (n⁻=n−1, provided that n⁻=N if n=1) distributed processing node of the N distributed processing nodes, the distributed processing system characterized in that each of the N distributed processing nodes generates pieces of distributed data for M groups, each of the M groups including an identical number of pieces of distributed data as the number of weights of a neural network that is a learning target, a first distributed processing node previously determined from among the N distributed processing nodes defines the pieces of distributed data for the M groups generated by the first distributed processing node as pieces of first consolidated data, and transmits the pieces of first consolidated data from the corresponding communication unit for each of the M groups of the first distributed processing node to a second distributed processing node of the N distributed processing nodes via the communication path for each of the M groups, a k-th (k=2, . . . , N) distributed processing node of the N distributed processing nodes excluding the first distributed processing node calculates, for each of the weights and for each of the M groups, a sum of first consolidated data of the pieces of first consolidated data for each of the M groups received from a (k−1)-th distributed processing node of the N distributed processing nodes via the M communication units of the k-th distributed processing node and distributed data for each of the M groups generated by the k-th distributed processing node, to generate pieces of updated first consolidated data, and transmits the pieces of updated first consolidated data from the corresponding communication unit for each of the M groups of the k-th distributed processing node to a k⁺-th (k⁺=k+1, provided that k⁺=1 if k=N) distributed processing node of the N distributed processing nodes via the communication path for each of the M groups, the first distributed processing node defines first consolidated data for each of the M groups received from an N-th distributed processing node of the N distributed processing nodes via the M communication units of the first distributed processing node as pieces of second consolidated data, and transmits the pieces of second consolidated data from the corresponding communication unit for each of the M groups of the first distributed processing node to the N-th distributed processing node via the communication path for each of the M groups, the k-th distributed processing node transmits second consolidated data of the pieces of second consolidated data for each of the M groups received from the k⁺-th distributed processing node via the M communication units of the k-th distributed processing node, from the corresponding communication unit for each of the M groups of the k-th distributed processing node to the (k−1)-th distributed processing node via the communication path for each of the M groups, the first distributed processing node receives the second consolidated data from the second distributed processing node via the M communication units of the first distributed processing node, and each of the N distributed processing nodes updates the weights of the neural network, in accordance with the second consolidated data that is received.

The present disclosure also relates to a distributed processing method in a system, the system including N (N being an integer equal to or greater than 2) distributed processing nodes arranged in a ring shape, each of the N distributed processing nodes being connected to an adjacent node via a communication path, an n-th (n=1, . . . , N) distributed processing node of the N distributed processing nodes including M (M being an integer equal to or greater than 2) communication units capable of simultaneous communication in both directions with an n⁺-th (n⁺=n+1, provided that n⁺=1 if n=N) distributed processing node of the N distributed processing nodes and an n⁻-th (n⁻=n−1, provided that n⁻=N if n=1) distributed processing node of the N distributed processing nodes, the distributed processing method characterized in including generating, by each of the N distributed processing nodes, pieces of distributed data for M groups, each of the M groups including an identical number of pieces of distributed data as the number of weights of a neural network that is a learning target, defining, by a first distributed processing node previously determined from among the N distributed processing nodes, the pieces of distributed data for the M groups generated by the first distributed processing node as pieces of first consolidated data, and transmitting the pieces of first consolidated data from the corresponding communication unit for each of the M groups of the first distributed processing node to a second distributed processing node of the N distributed processing nodes via the communication path for each of the M groups, calculating, by a k-th (k=2, . . . , N) distributed processing node of the N distributed processing nodes excluding the first distributed processing node, for each of the weights and for each of the M groups, a sum of first consolidated data of the pieces of first consolidated data for each of the M groups received from a (k−1)-th distributed processing node of the N distributed processing nodes via the M communication units of the k-th distributed processing node and distributed data for each of the M groups generated by the k-th distributed processing node, to generate pieces of updated first consolidated data, and transmitting the pieces of updated first consolidated data from the corresponding communication unit for each of the M groups of the k-th distributed processing node to a k⁺-th (k⁺=k+1, provided that k⁺=1 if k=N) distributed processing node of the N distributed processing nodes via the communication path for each of the M groups, defining, by the first distributed processing node, first consolidated data for each of the M groups received from an N-th distributed processing node of the N distributed processing nodes via the M communication units of the first distributed processing node as pieces of second consolidated data, and transmitting the pieces of second consolidated data from the corresponding communication unit for each of the M groups of the first distributed processing node to the N-th distributed processing node via the communication path for each of the M groups, transmitting, by the k-th distributed processing node, second consolidated data of the pieces of second consolidated data for each of the M groups received from the k⁺-th distributed processing node via the M communication units of the k-th distributed processing node, from the corresponding communication unit for each of the M groups of the k-th distributed processing node to the (k−1)-th distributed processing node via the communication path for each of the M groups, receiving, by the first distributed processing node, the second consolidated data from the second distributed processing node via the M communication units of the first distributed processing node, and updating, by each of the N distributed processing nodes, the weights of the neural network, in accordance with the second consolidated data that is received.

### EFFECTS OF EMBODIMENTS OF THE INVENTION

According to the present disclosure, it is not necessary to postpone a start of dispatch communication (a process of distributing second consolidated data from an n-th distributed processing node to each of n⁻-th distributed processing nodes) until aggregation communication (a process of transmitting first consolidated data from the n-th distributed processing node to the n⁺-th distributed processing node) is completed. In the present disclosure, it is possible to start dispatch communication from a part of data already consolidated, even during the aggregation communication, and thus, as compared with the known art in which the dispatch communication is started after the aggregation communication is completed, it is possible to reduce the time from the start of the aggregation communication to the completion of the dispatch communication, and therefore, it is possible provide a distributed system for deep learning having higher speed. In the present disclosure, the distributed processing nodes are connected by M communication paths and M communication units included in each of the distributed processing nodes each perform aggregation communication and dispatch communication. Thus, in the present disclosure, as compared to a distributed system in which the aggregation communication and the dispatch communication are performed by one communication unit included in each of the distributed processing nodes, the amount of data transferred by each of the communication paths and each of the communication units can be reduced to 1/M. As a result, in the present disclosure, it is possible to significantly reduce the time required for transferring data. In addition, in the present disclosure, when a first distributed processing node completes acquisition of second consolidated data, it is guaranteed that acquisition of the second consolidated data by the other distributed processing nodes is completed, and thus, it is possible to provide a distributed processing system for deep learning with high reliability.

### BRIEF DESCRIPTION OF DRAWINGS

FIG. 1 is a block diagram illustrating a configuration example of a distributed processing system for deep learning according to a first embodiment of the present disclosure.

FIG. 2 is a block diagram illustrating a configuration example of a distributed processing node according to the first embodiment of the present disclosure.

FIG. 3 is a block diagram illustrating a configuration example of the distributed processing node according to the first embodiment of the present disclosure.

FIG. 4 is a flowchart for describing a sample data input process, a gradient calculation process, and an in-node consolidation process of the distributed processing node according to the first embodiment of the present disclosure.

FIG. 5 is a diagram illustrating a sequence of an aggregation communication process, an inter-node consolidation process, and a dispatch communication process of the distributed processing node according to the first embodiment of the present disclosure.

FIG. 6 is a diagram illustrating a sequence of the aggregation communication process, the inter-node consolidation process, and the dispatch communication process of the distributed processing node according to the first embodiment of the present disclosure.

FIG. 7 is a diagram illustrating a sequence of the aggregation communication process, the inter-node consolidation process, and the dispatch communication process of the distributed processing node according to the first embodiment of the present disclosure.

FIG. 8 is a flowchart for describing a weight updating process of the distributed processing node according to the first embodiment of the present disclosure.

FIG. 9 is a block diagram illustrating a configuration example of a distributed processing system for deep learning according to a second embodiment of the present disclosure.

FIG. 10 is a block diagram illustrating a configuration example of a distributed processing node according to the second embodiment of the present disclosure.

FIG. 11 is a block diagram illustrating a configuration example of the distributed processing node according to the second embodiment of the present disclosure.

FIG. 12 is a block diagram illustrating a configuration example of a computer that realizes the distributed processing node according to the first and second embodiments of the present disclosure.

FIG. 13 is a graph showing a relationship between the number of distributed processing nodes and a processing performance of deep learning in a conventional distributed processing system

### DETAILED DESCRIPTION OF EMBODIMENTS

### First Embodiment

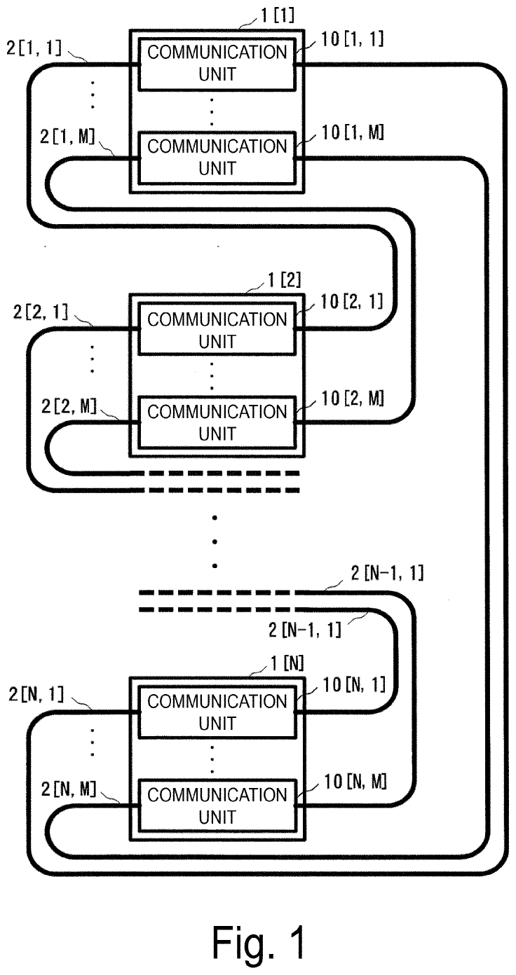

Hereinafter, embodiments of the present disclosure will be described with reference to the drawings. FIG. 1 is a block diagram illustrating a configuration example of a distributed processing system for deep learning according to a first embodiment of the present disclosure. The distributed processing system in FIG. 1 includes N (N being an integer equal to or greater than 2) distributed processing nodes 1[n] (n=1, . . . , N), and M (M being an integer equal to or greater than 2) communication paths 2[n, m] (n=1, . . . , N, m=1, . . . , M) through which a distributed processing node 1[n] of a number n and a distributed processing node 1[n⁺] of the following number n⁺(n⁺=n+1, provided that n⁺=1 if n=N) communicate with each other in both directions. Note that, in addition to a transmission line, a relay processing node that relays communication can be optionally interposed in any one of the communication paths 2[n, m].

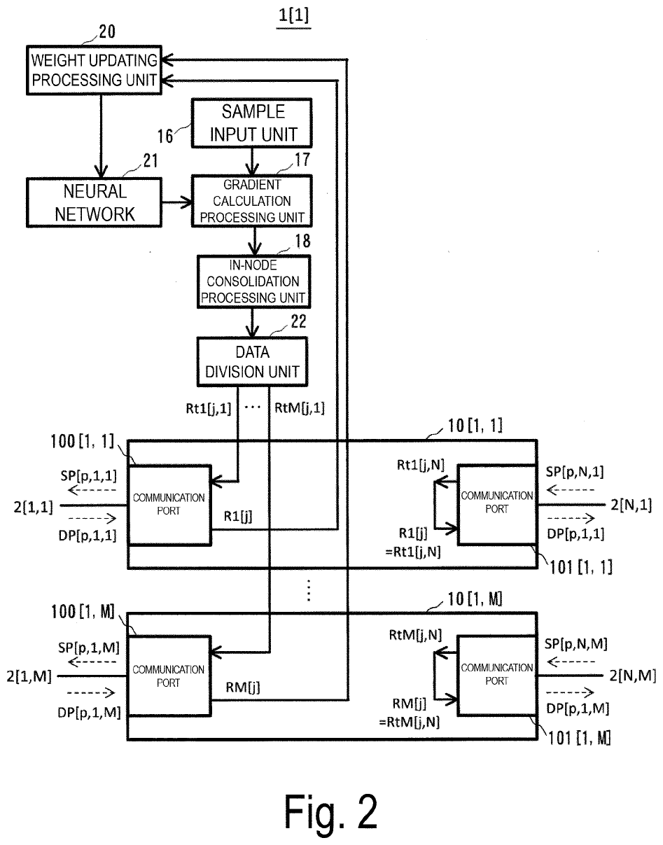

FIG. 2 is a block diagram illustrating a configuration example of a distributed processing node 1[1]. The distributed processing node 1[1] includes M communication units 10[1, m] (n=1, . . . , N, m=1, . . . , M) being provided for each group and being capable of simultaneous communication in both directions, a sample input unit 16, a gradient calculation processing unit 17, an in-node consolidation processing unit 18, a weight updating processing unit 20, a neural network 21 being a mathematical model constructed by software, and a data division unit 22. The sample input unit 16 receives training sample data from a data collecting node not illustrated in the drawing. When the sample data is input, the gradient calculation processing unit 17 calculates a gradient G[z, 1, s] of a loss function of a neural network for each piece of the sample data with respect to each weight w[z] of the neural network. The in-node consolidation processing unit 18 generates and stores distributed data D[z, 1], being a numerical value obtained by consolidating the gradients G[z, 1, s] of each piece of the sample data, for each weight w[z]. The weight updating processing unit 20 updates a weight of a neural network, based on the consolidated data. The data division unit 22 divides the distributed data D[z, 1] generated by the in-node consolidation processing unit 18 into M groups.

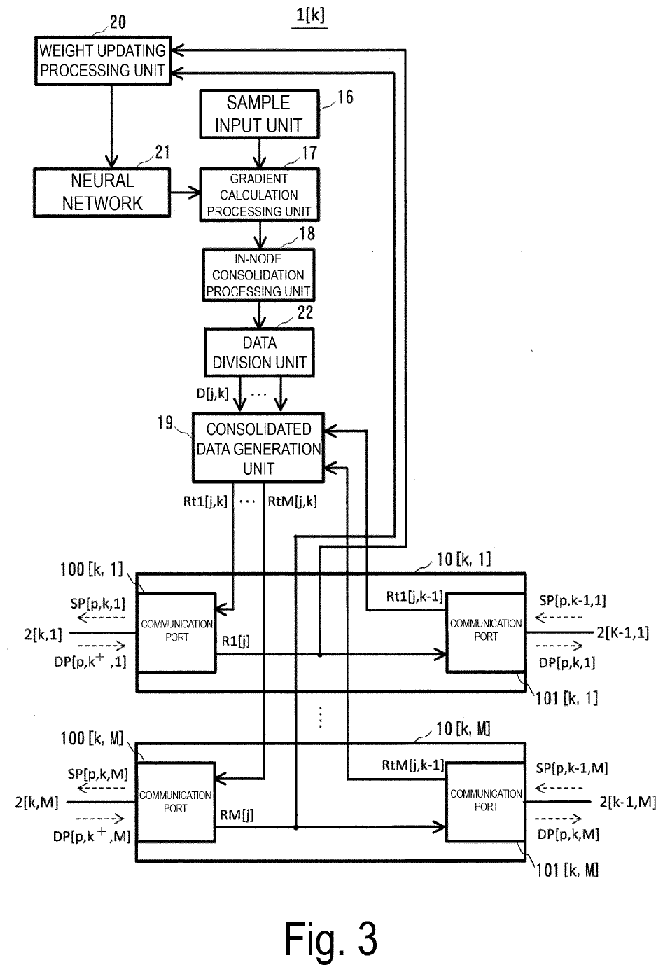

FIG. 3 is a block diagram illustrating a configuration example of a distributed processing node 1[k] (k=2, . . . , N). The distributed processing node 1[k] includes M communication units 10[k, m] being provided for each group and being capable of simultaneous communication in both directions, the sample input unit 16, the gradient calculation processing unit 17, the in-node consolidation processing unit 18, a consolidated data generation unit 19, the weight updating processing unit 20, the neural network 21, and the data division unit 22. When sample data is input, the gradient calculation processing unit 17 calculates a gradient G[z, k, s] of a loss function of a neural network for each piece of the sample data with respect to each weight w[z] of the neural network. The in-node consolidation processing unit 18 generates and stores distributed data D[z, k], being a numerical value obtained by consolidating the gradients G[z, k, s] of each piece of the sample data, for each weight w[z]. The consolidated data generation unit 19 calculates, for each weight and for each group, the sum of received intermediate consolidated data and the distributed data D[z, k] generated by the distributed processing node 1[k], to generate updated intermediate consolidated data. The data division unit 22 divides the distributed data D[z, k] generated by the in-node consolidation processing unit 18 into M groups.

The communication unit 10[n, m] of each of the distributed processing nodes 1[n] includes a communication port 100[n, m] and a communication port 101[n, m] capable of simultaneous communication in both directions. The communication port 100[n, m] is a communication port through which the distributed processing node 1[n] communicates in both directions with the distributed processing node 1[n⁺] (n⁺=n+1, provided that n⁺=1 if n=N), and is connected to the communication path 2[n, m]. The communication port 101[n, m] is a communication port through which the distributed processing node 1[n] communicates in both directions with a distributed processing node [n⁻] (n⁻=n−1, provided that n⁻=N if n=1), and is connected to a communication path 2[n⁻, m].

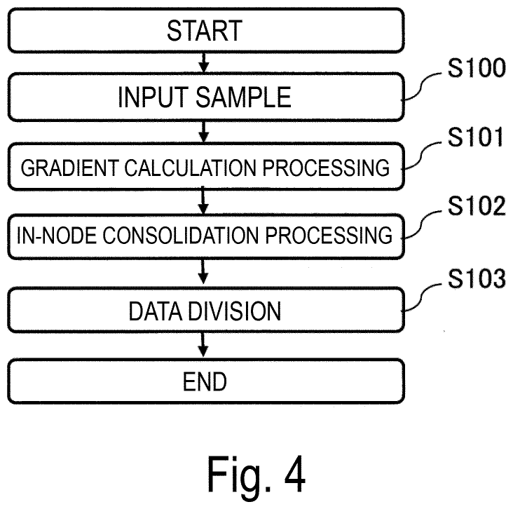

FIG. 4 is a flowchart for describing a sample data input process, a gradient calculation process, and an in-node consolidation process of the distributed processing node 1[n]. The sample input unit 16 of each of the distributed processing nodes 1[n] inputs S different pieces of sample data x[n, s] (s=1, . . . , S) (S being an integer equal to or greater than 2) for each mini batch from a data collecting node not illustrated in the drawing (step S100 in FIG. 4).

Note that embodiments of the present disclosure are not limited to a sample data collecting method performed by a data collecting node and a method of dividing collected sample data into N sets and distributing each of the sets to each of the distributed processing nodes 1[n], and any method can be applied.

When sample data x[n, s] is input, the gradient calculation processing unit 17 of each of the distributed processing nodes 1[n] calculates a gradient G[z, n, s] of a loss function of the neural network 21 for each piece of the sample data x[n, s] with respect to each of z weights w[z] (z=1, . . . , Z) (Z being an integer equal to or greater than 2) of the neural network 21 that is a leaning target (step S101 in FIG. 4).

A method of constructing the neural network 21 in each of the distributed processing nodes 1[n] by software, and techniques relating to the weight w[z] of the neural network 21, the loss function being an indicator indicating the degree of poorness of performance of the neural network 21, and the gradient G[z, n, s] of the loss function are well-known techniques, and thus detailed description thereof will be omitted.

Next, the in-node consolidation processing unit 18 of each of the distributed processing nodes 1[n] generates and stores distributed data D[z, n] (z=1, . . . , Z), being a numerical value obtained by consolidating the gradients G[z, n, s] of each piece of sample data, for each of the weights w[z] (step S102 in FIG. 4). An equation for calculating the distributed data D[z, n] is as follows.

D[z,n]=Σ_{s=1, . . . , s}G[z,n,s] . . . (1)

Note that the gradient calculation process in step S101 and the in-node consolidation process in step S102 can be performed in a pipelined manner in units of sample data (the gradient calculation process for any sample data and the in-node consolidation process of consolidating a gradient obtained from one sample data prior to the sample data can be performed at the same time).

The data division unit 22 of each of the distributed processing nodes 1[n] divides Z pieces of the distributed data D[z, n] generated by the in-node consolidation processing unit 18 into M pieces of the distributed data D[z, n] (step S103 in FIG. 4).

When the data transfer speed of all the communication units 10[n, m] (n=1, . . . , N, m=1, . . . , M) is the same, it is desirable that the data division unit 22 divides (groups) the distributed data into equal amounts of data, in order to increase the speed of an inter-node consolidation process described later. An example of such a method of dividing data includes a method of dividing Z pieces of distributed data D[z, n] into Z/M pieces of data, in the order of the number z. That is, each element of the M groups is D[j, n] (j=Z/M*(m−1)+Z/M*m, n=1, . . . , N, m=1, . . . , M), and thus, it is possible to have an equal amount of data in each group.

However, this division method can only be used when Z/M is an integer. When Z/M is not an integer, the data division unit 22 divides the data so that the number of pieces of distributed data belonging to each group is as close as possible to Z/M. As can be understood from the description above, the number j takes a numerical value in a different range for each group (each communication unit) within each of the distributed processing nodes 1[n], among weight numbers z.

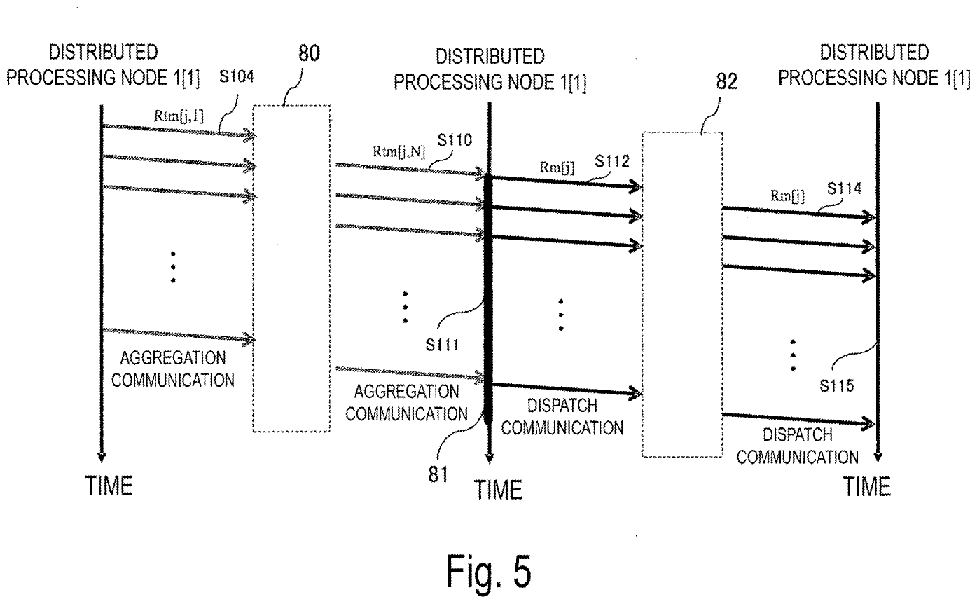

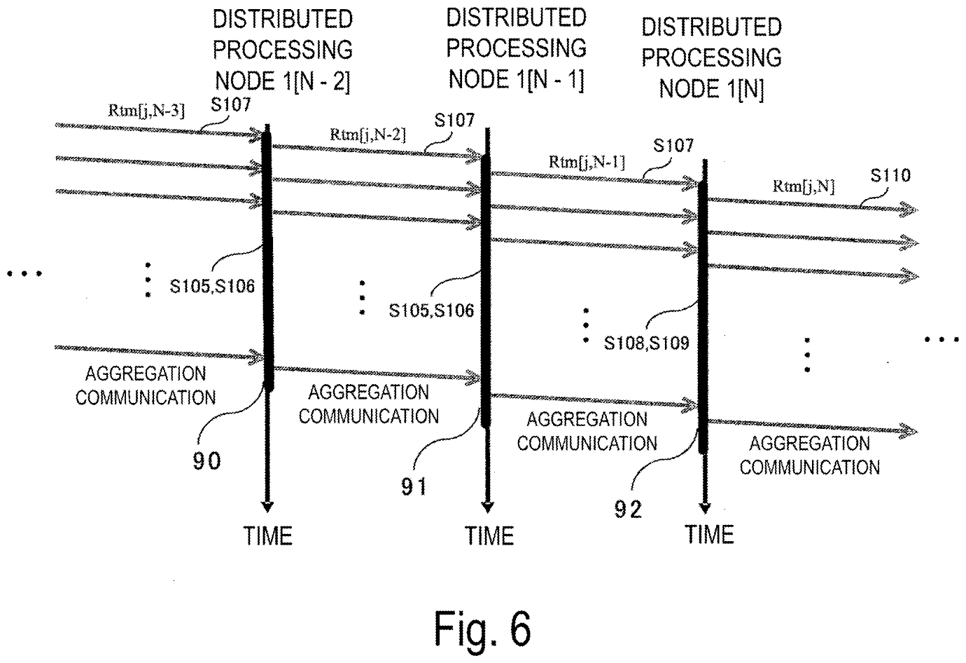

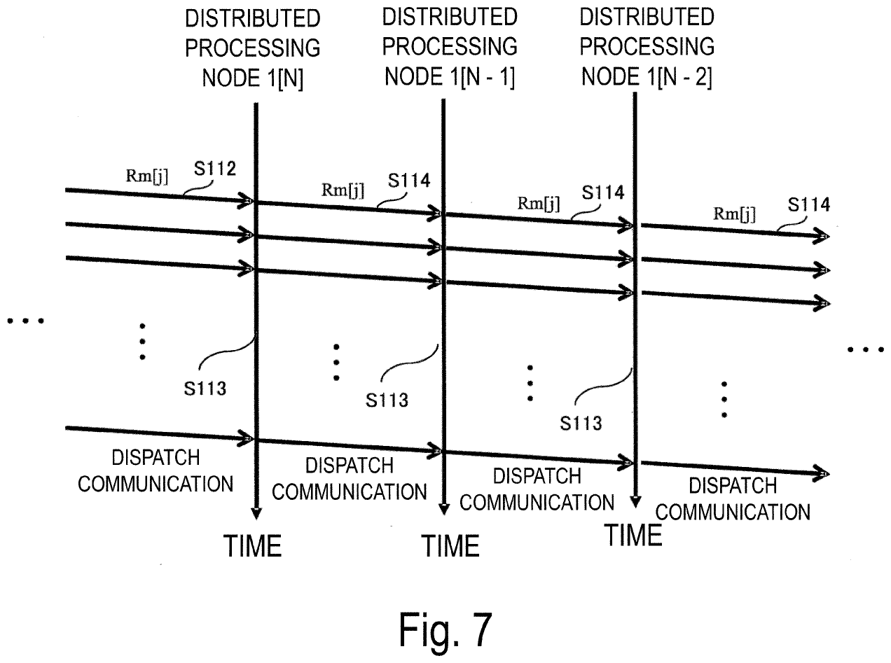

Furthermore, each of the distributed processing nodes 1[n] generates distributed data D[j, n], and then performs aggregation communication between the distributed processing nodes, to perform an inter-node consolidation process of generating consolidated data. FIGS. 5 to 7 illustrate sequences of an aggregation communication process, an inter-node consolidation process, and a dispatch communication process of each of the distributed processing nodes 1[n]. Note that FIG. 6 illustrates a part of a process indicated by a reference numeral 80 in FIG. 5. A reference numeral 81 denotes an inter-node consolidation process at the distributed processing node 1[1]. Similarly, reference numerals 90, 91, and 92 in FIG. 6 denote inter-node consolidation processes at distributed processing nodes 1[N-2], 1[N-1], and 1[N]. FIG. 7 illustrates a part of a process indicated by a reference numeral 82 in FIG. 5, that is, dispatch communication processes of the distributed processing nodes 1[N], 1[N-1], and 1[N-2].

First, each communication unit 10[1, m] of the first distributed processing node 1[1] previously determined from among a plurality of the distributed processing nodes 1[n] defines distributed data D[j, 1] generated by the data division unit 22 of the first distributed processing node 1[1] as intermediate consolidated data Rtm[j, 1], packetizes the intermediate consolidated data Rtm[j, 1], and outputs generated aggregation communication packets SP[p, 1, m] (p=1, . . . , P, P being an integer equal to or greater than 2) to a communication port 100[1, m]. The aggregation communication packets SP[p, 1, m] of the M groups are transmitted from each of the communication ports 10[1, m] to a distributed processing node 1[2] assigned with a succeeding number, via a communication path 2[1, m] (step S104 in FIG. 5). The intermediate consolidated data intermediate consolidated data Rtm[j, 1] at this time is the same as the distributed data D[j, 1].

Rtm[j, 1]=D[j, 1] . . . (2)

Next, each of the communication units 10[i, m] of intermediate distributed processing nodes 1[i] (i=2, . . . , N−1) previously determined, except the first and the N-th distributed processing nodes 1[n], from among the plurality of distributed processing nodes 1[n] receives the aggregation communication packet SP[p, i−1, m] (p=1, . . . , P) from each of the distributed processing nodes 1[i−1] via the communication path 2[i−1, m] and the communication port 101[i, m], and acquires intermediate consolidated data Rtm[j, i−1] from the received aggregation communication packet SP[p, i−1, m] (step S105 in FIG. 5).

Each of the consolidated data generation units 19 of the intermediate distributed processing nodes 1[i] (i=2, . . . , N−1) calculates, for each corresponding weight w[j] (each number j) and for each group, the sum of the intermediate consolidated data Rtm[j, i−1] acquired by the communication unit 10[i, m] of the intermediate distributed processing node 1[i] and D[j, i] generated by the data division unit 22 of the intermediate distributed processing node 1[i], to generate intermediate consolidated data Rtm[j, i] for each group (step S106 in FIG. 5). An equation for calculating the intermediate consolidated data Rtm[j, i] is as follows.

Rtm[j, i]=Rtm[j, i−1]+D[j, i] . . . (3)

Subsequently, each of the communication units 10[i, m] of the intermediate distributed processing nodes 1[i] (i=2, . . . , N−1) packetizes the intermediate consolidated data Rtm[j, i] generated by the consolidated data generation unit 19 of the intermediate distributed processing node 1[i], and outputs the generated aggregation communication packet SP[p, i, m] (p=1, . . . , P) to the communication port 100[i, m]. The aggregation communication packet SP[p, i, m] is transmitted from each of communication ports 100[i, m] to the distributed processing node 1[i+1] assigned with a succeeding number, via the communication path 2[i, m] (step S107 in FIG. 5).

Each of the communication units 10[N, m] of the N-th distributed processing node 1[N] previously determined from among the plurality of distributed processing nodes 1[n] receives the aggregation communication packet SP[p, N-1, m] (p=1, . . . , P) from each of the distributed processing nodes 1[N-1] via the communication path 2[N-1, m] and the communication port 101[N, m], and acquires intermediate consolidated data Rtm[j, N-1] from the received aggregation communication packet SP[p, N-1, m] (step S108 in FIG. 5).

The consolidated data generation unit 19 of the N-th distributed processing node 1[N] calculates, for each corresponding weight w[j] (each number j) and for each group, the sum of the intermediate consolidated data Rtm[j, N-1] acquired by the communication unit 10[N, m] (m=1, . . . , M) of the N-th distributed processing node 1[N] and D[j, N] generated by the data division unit 22 of the N-th distributed processing node 1[N], to generate intermediate consolidated data Rtm[j, N] for each group (step S109 in FIG. 5). An equation for calculating the intermediate consolidated data Rtm[j, N] is as follows.

Rtm[j, N]=Rtm[j, N-1]+D[j, N] . . . (4)

Subsequently, each of the communication units 10[N, m] of the N-th distributed processing node 1[N] packetizes the intermediate consolidated data Rtm[j, N] generated by the consolidated data generation unit 19 of the N-th distributed processing node 1[N], and outputs the generated aggregation communication packet SP[p, N, m] (p=1, . . . , P) to the communication port 100[N, m]. The aggregation communication packet SP[p, N, m] is transmitted from each of communication ports 100[N, m] to the first distributed processing node 1[1], via the communication path 2[N, m] (step S110 in FIG. 5).

Thus, the intermediate consolidated data Rtm[j, N] calculated using Equation (2), Equation (3), and Equation (4), is calculated based on the D[j, N] generated by each of the distributed processing nodes 1[n]. A numerical value of the intermediate consolidated data Rtm[j, N] can be expressed by the following equation.

Rtm[j, N]Σ_{n=1, . . . ,N}D[j, N] . . . (5)

Next, dispatch communication is performed in which the intermediate consolidated data Rtm[j, N] is distributed as consolidated data Rm[j] to each of the distributed processing nodes 1[n].

Each of the communication units 10[1, m] of the first distributed processing node 1[1] receives the aggregation communication packet SP[p, N, m] (p=1, . . . , P) from the distributed processing node 1[N] via the communication path 2[N, m] and the communication port 101[1, m] of the first distributed processing node 1[1], and acquires intermediate consolidated data Rtm[j, N] from the received aggregation communication packet SP[p, N, m] (step S111 in FIG. 5).

Each of the communication units 10[1, m] of the first distributed processing node 1[1] defines the received intermediate consolidated data Rtm[j, N] as consolidated data Rm[j], packetizes the consolidated data Rm[j], and outputs the generated dispatch communication packet DP[p, 1, m] (p=1, . . . , P) to the communication port 101[1, m] of the first distributed processing node 1[1]. The dispatch communication packet DP[p, m] is transmitted from each of the communication ports 101[1, m] to the N-th distributed processing node 1[N], via the communication path 2[N, m] (step S112 in FIG. 5). That is, the distributed processing node 1[1] returns the intermediate consolidated data Rtm[j, N] from the distributed processing node 1[N], as the consolidated data Rm[j], to the distributed processing node 1[N]. The consolidated data Rm[j] is the same as the intermediate consolidated data Rtm[j, N].

Rm[j]=Rtm[j, N]=Σ_{n=1, . . . , N}D[j, N] . . . (6)

Subsequently, each of the communication units 10[k, m] of the distributed processing nodes 1[k] (k =N, 2) of the plurality of distributed processing nodes 1[n], except the first distributed processing node 1, receives the dispatch communication packet DP[p, k⁺, m] (p=1, . . . , P) from the distributed processing node 1[k⁺] (k⁺=k+1, provided that k⁺=1 if k=N) assigned with a succeeding number, via the communication path 2[k, m] and the communication port 100[k, m] of the distributed processing node 1[k], and acquires consolidated data Rm[j] from the received dispatch communication packet DP[p, k+, m] (step S113 in FIG. 5).

Each of the communication units 10[k, m] of the distributed processing nodes 1[k] (k=N, . . . , 2) packetizes the received consolidated data Rm[j] and outputs the generated dispatch communication packet DP[p, k, m] (p=1, . . . , P) to the communication port 101[k, m] of the distributed processing node 1[k]. The dispatch communication packet DP[p, k, m] is transmitted from each of the communication ports 101[k, m] to a distributed processing node 1[k−1], via a communication path 2[k−1, m] (step S114 in FIG. 5).

Each of the communication units 10[1, m] of the first distributed processing node 1[1] receives the dispatch communication packet DP[p, 2, m] (p=1, . . . , P) from the distributed processing node 1[2] via the communication path 2[1, m] and the communication port 100[1, m] of the first distributed processing node 1[1], and acquires consolidated data Rm[j] from the received dispatch communication packet DP[p, 2, m] (step S115 in FIG. 5).

Here, in order for the first distributed processing node 1[1] to successfully receive the consolidated data Rm[j], another distributed processing node 1[k] (k=N, . . . , 2) needs to successfully receive the consolidated data Rm[j]. The communication path 2[n, m] (n=1, . . . , N) and the communication unit 10[n, m] do not have a function of returning an error of the consolidated data Rm[j] to a normal state.

Thus, in a case where the M communication units 10[1, m] included in the distributed processing node 1[1] successfully receive the consolidated data Rm[j], it is guaranteed that all of the distributed processing nodes 1[n] have successfully received the consolidated data Rm[j]. In a case where at least one of the communication units 10[1, m] of the distributed processing node 1[1] fails to successfully receive the consolidated data Rm[j], the process may return to step S104 to be restarted from the aggregation communication.

Note that, whether each of the communication units 10[1, m] of the distributed processing node 1[1] has successfully received the consolidated data Rm[j] can be determined by comparing the consolidated data Rm[j] transmitted in step 5112 with the consolidated data Rm[j] received in step S115, for example. That is, when the transmitted consolidated data Rm[j] matches the received consolidated data Rm[j], it can be determined that the consolidated data Rm[j] is successfully received.

With the above-described dispatch communication, all of the distributed processing nodes 1[n] can acquire the same consolidated data Rm[j]. The aggregation communication is performed by using a route of the distributed processing node 1[1] ->the distributed processing node 1[2] ->. . . ->the distributed processing node 1[N] ->the distributed processing node 1[1]. The dispatch communication is performed by using a route of the distributed processing node 1[1] ->the distributed processing node 1[N] ->. . . ->the distributed processing node 1[2] ->the distributed processing node 1[1].

That is, the direction of the aggregation communication and the direction of the dispatch communication are opposite to each other. The aggregation communication and the dispatch communication are performed via the communication ports 100[n, m] and 101[n, m] and the communication path 2[n, m] that can simultaneously communicate in both directions, and thus, it is not necessary to postpone a start of the dispatch communication until the aggregation communication is completed.

That is, in a case where the distributed processing node 1[1] starts to receive the intermediate consolidated data Rtm[j, N] before the distributed processing node 1[1] completes the transmission of the intermediate consolidated data Rtm[j, 1], the dispatch communication using this intermediate consolidated data intermediate consolidated data Rtm[j, N] as the consolidated data Rm[j] can be started.

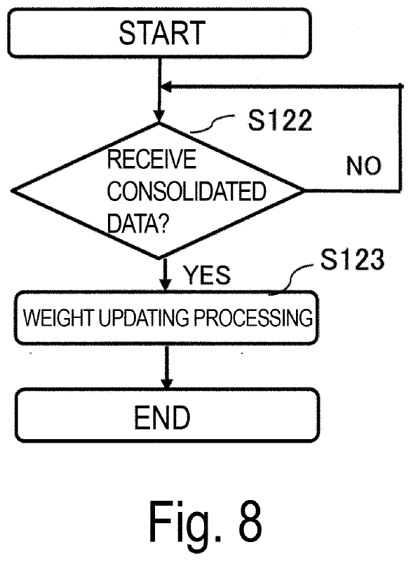

FIG. 8 is a flowchart for describing a weight updating process of the distributed processing node 1[n]. The weight updating processing unit 20 of each of the distributed processing nodes 1[n] performs, when receiving the consolidated data Rm[j] acquired by the communication unit 10[n, m] of the distributed processing node 1[n] (YES in step S122 of FIG. 8), a weight updating process of updating the weight w[j] of the neural network 21 in the distributed processing node 1[n], based on the received consolidated data Rm[j] (step S123 in FIG. 8). In the weight updating process, a weight w[j] may be updated for each number j so that a loss function is minimized, based on a gradient of the loss function indicated by the consolidated data Rm[j]. The updating of a weight w[j] is a well-known technique, and thus, detailed description thereof will be omitted.

As described above, the weight updating process is a process of updating the weight w[j], based on the pieces of consolidated data Rm[j] acquired in the order of the number j of the weights w[j]. Thus, each of the distributed processing nodes 1[n] can perform the weight updating process for the weights w[j] in the order of the number j.

When one mini batch learning is terminated due to the termination of the weight updating process, each of the distributed processing nodes 1[n] (n=1, . . . , N) continuously performs the next mini batch learning, process based on the updated weight. That is, each of the distributed processing nodes 1[n] receives sample data for the next mini batch learning from a data collecting node which is not shown in the drawing, and repeats the above-described mini batch learning process to improve the accuracy of inference of the neural network of the distributed processing node 1[n].

As illustrated in the present embodiment, it is not necessary to postpone a start of the dispatch communication until the aggregation communication is completed, and it is possible to start the dispatch communication from a portion of data that has been consolidated, even during the aggregation communication. Thus, it is possible to reduce the time from the start of the aggregation communication to the completion of the dispatch communication as compared with the known art in which the dispatch communication is started after the aggregation communication is completed, and therefore, it is possible provide a distributed system for deep learning having higher speed.

In the present embodiment, the distributed processing nodes are connected by M communication paths 2[n, m] and M communication units 10[n, m] included in each of the distributed processing nodes 1[n] each perform aggregation communication and dispatch communication. Thus, in the present embodiment, the amount of data transferred through each of the communication paths 2[n, m] and each of the communication units 10[n, m] can be reduced to 1/M as compared to a distributed system in which aggregation communication and dispatch communication are performed by one communication unit included in each of the distributed processing nodes. As a result, in the present embodiment, it is possible to significantly reduce the time required for transferring data in a distributed processing system in which the time required for transferring data takes up a major part of the time needed for aggregation communication and dispatch communication.

In addition, in the present embodiment, when the distributed processing node 1[1] completes the acquisition of the consolidated data Rm[j], it is guaranteed that the acquisition of the consolidated data Rm[j] by the other distributed processing nodes 1[k] (k=2, . . . , N) is completed, and thus, it is possible to provide a distributed processing system for deep learning with high reliability.

### Second Embodiment

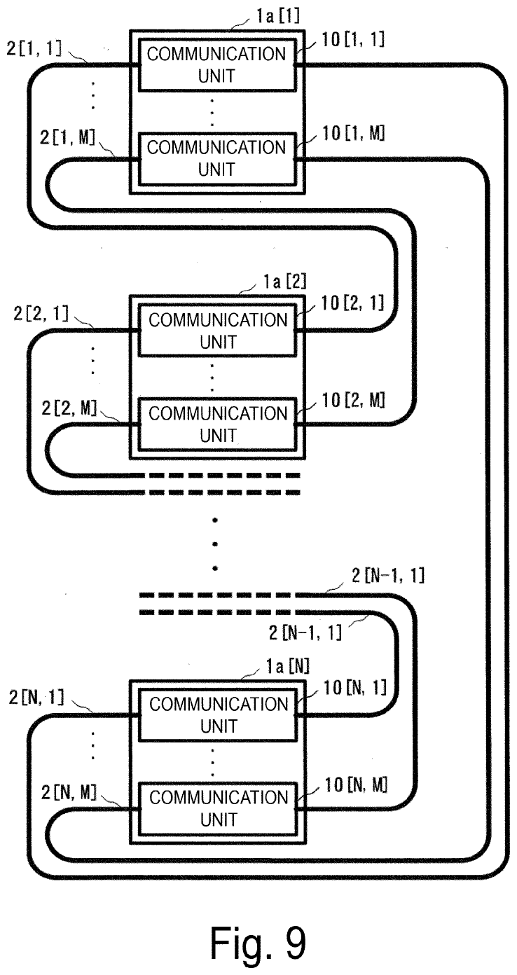

Next, a second embodiment of the present disclosure will be described. FIG. 9 is a block diagram illustrating a configuration example of a distributed processing system for deep learning according to the second embodiment of the present disclosure. The distributed processing system in FIG. 9 includes N distributed processing nodes 1a[n] (n=1, . . . , N) and the M communication paths 2[n, m] (n=1, . . . , N, m=1, . . . , M). Note that, in addition to a transmission line, a relay processing node that relays communication can be optionally interposed in any one of the communication paths 2[n, m].

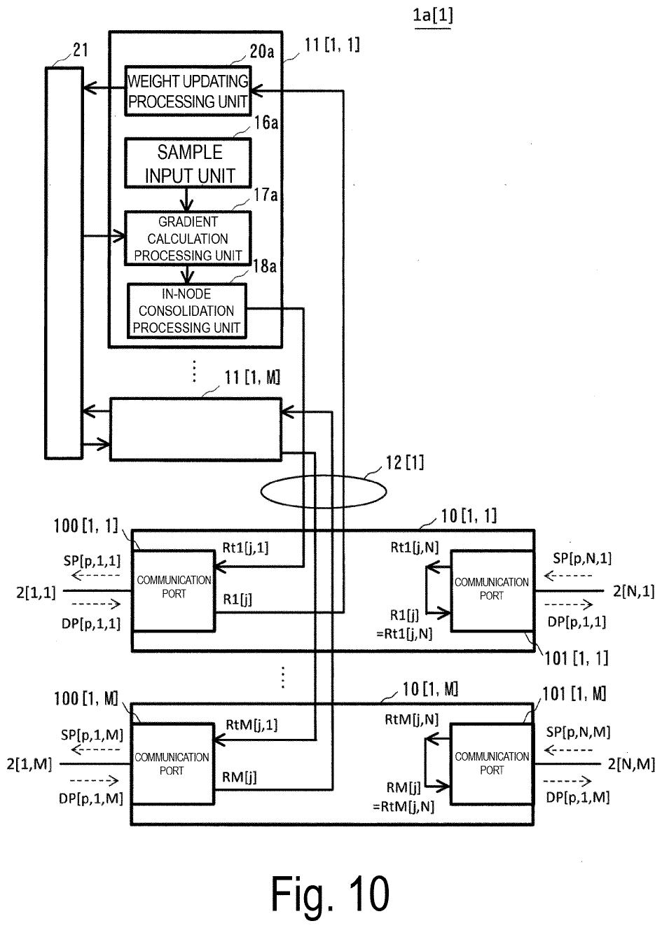

FIG. 10 is a block diagram illustrating a configuration example of a distributed processing node 1a[1]. The distributed processing node 1a[i] includes M communication units 10[1, m], M distributed data generation units 11[1, m], and the neural network 21. The communication unit 10[1, m] and the distributed data generation unit 11[1, m] are connected by an internal communication path 12[1]. Each of the distributed data generation units 11[1, m] includes a sample input unit 16a, a gradient calculation processing unit 17a, an in-node consolidation processing unit 18a, and a weight updating processing unit 20a.

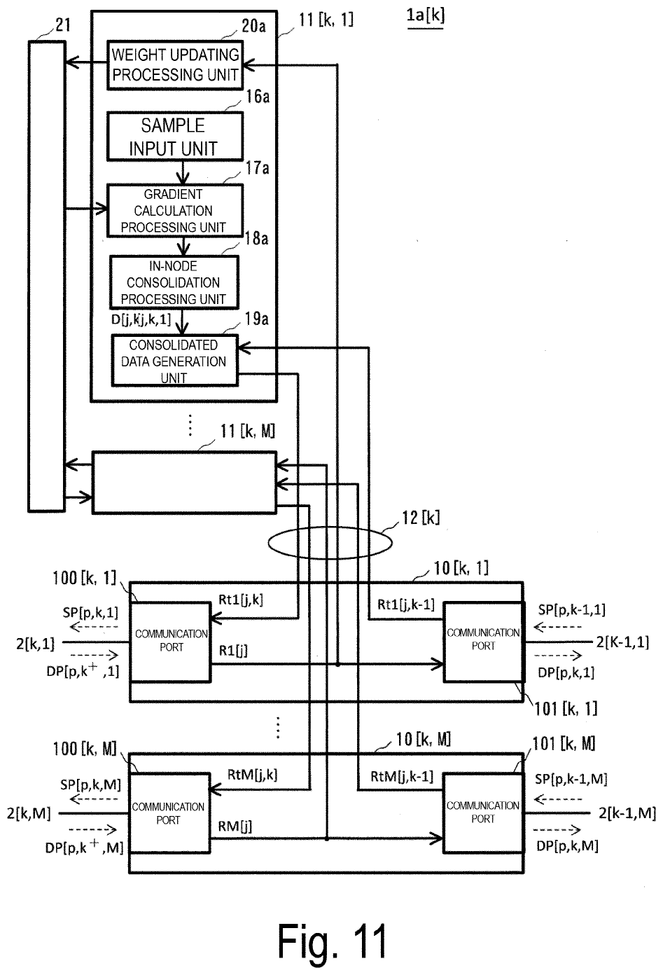

FIG. 11 is a block diagram illustrating a configuration example of a distributed processing node 1a[k] (k=2, . . . , N). The distributed processing node 1a[k] includes M communication units 10[k, m], M distributed data generation units 11[k, m], and the neural network 21. The communication unit 10[k, m] and the distributed data generation unit 11[k, m] are connected by an internal communication path 12[k]. Each of the distributed data generation units 1[k, m] includes the sample input unit 16a, the gradient calculation processing unit 17a, the in-node consolidation processing unit 18a, a consolidated data generation unit 19a, and the weight updating processing unit 20a.

The communication unit 10[n, m] of each of the distributed processing nodes 1a[n] includes the communication port 100[n, m] and the communication port 101[n, m] that can simultaneously communicate in both directions. The communication port 100[n, m] is a communication port through which the distributed processing node 1a[n] communicates in both directions with a distributed processing node 1a[n⁺] (n⁺=n+1, provided that n⁺=1 if n=N), and is connected to the communication path 2[n, m]. The communication port 101[n, m] is a communication port through which the distributed processing node 1a[n] communicates in both directions with the distributed processing node [n⁻] (n⁻=n−1, provided that n⁻=N if n=1), and is connected to a communication path 2[n⁻, m].

In the present embodiment, a flow of a sample data input process, a gradient calculation process, and an in-node consolidation process of the distributed processing node 1a[n] is similar to that in the first embodiment. The sample input unit 16a in each of the distributed data generation units 11[n, m] of each of the distributed processing nodes 1a[n] inputs S different pieces of sample data x[n, m, s] (s=1, . . . , S) (S being an integer equal to or greater than 2) for each mini batch from each of data collecting nodes not illustrated in the drawing (step S100 in FIG. 4).

When sample data x[n, m, s] is input, the gradient calculation processing unit 17a in each of the distributed data generation units 11[n, m] of each of the distributed processing nodes 1a[n] calculates a gradient G[z, n, m, s] of a loss function of the neural network 21 for each piece of sample data x[n, m, s] with respect to each of Z weights w[z] (z=1, . . . , Z) (Z being an integer equal to or greater than 2) of the neural network 21 that is a learning target (step S101 in FIG. 4).

Subsequently, the in-node consolidation processing unit 18a in each of the distributed data generation units 11[n, m] of each of the distributed processing nodes 1a[n] performs an in-node consolidation process (step S102 in FIG. 4). In the in-node consolidation process in the present embodiment, the gradients G[z, n, m, s] of each piece of sample data x calculated by the distributed processing node 1[n] are consolidated via the internal communication path 12[n], to generate distributed data D[j, n]. In the in-node consolidation process, the in-node consolidation processing units 18a in the distributed data generation units 11[n, m] acquire pieces of distributed data D[j, n] in a different range of weight numbers j. An equation for calculating the distributed data D[j, n] is as follows.

D[j, n]=Σ_{m=1, . . . ,M}Σ_{s=1, . . . ,s}G[j, n, m, s] . . . (7)

Similarly to the first embodiment, the number j is a numerical value in a different range in each group (each distributed data generation unit) in each of the distributed processing nodes 1a[n], among the weight numbers z. An example of the in-node consolidation process described above includes a process called “ring all reduce” (Literature: “K Fukuda, Yuichiro Ueno, “Technology Supporting Distributed Deep Learning: All Reduce Algorithm”, 2018, Link: <https://research.preferred.jp/2018/07/prototype-allreduce-library/>). In the present embodiment, not all pieces of distributed data D[z, n] are stored in each of the distributed data generation units 11[n, m]. Only a numerical value constituting the distributed data D[j, m], that is, only a numerical value constituting one group when all the pieces of distributed data D[z, m] are divided into M groups, is stored in the distributed data generation unit 11 corresponding to the group. Consequently, each of the distributed data generation units 11[n, m] can acquire the distributed data D[j, m] by only performing an efficient in-node consolidation process as illustrated in the example above.

Furthermore, each of the distributed processing nodes 1a[n] transfers distributed data [j, n] from each of the distributed data generation units 11[n, m] to the communication units 10[n, m] via the internal communication path 12[n], performs aggregation communication between the distributed processing nodes, and performs an inter-node consolidation process for generating consolidated data.

In the present embodiment, a flow of an aggregation communication process, an inter-node consolidation process, and a dispatch communication process of the distributed processing node 1a[n] is similar to that in the first embodiment. First, each communication unit 10[1, m] of the first distributed processing node 1a[1] previously determined from among a plurality of the distributed processing nodes 1a[n] defines distributed data D[j, 1] transferred from each corresponding distributed data generation unit 11[1, m] as intermediate consolidated data Rtm[j, 1], packetizes the intermediate consolidated data Rtm[j, 1], and outputs the generated aggregation communication packet SP[p, i, m] (p=1, . . . , P) to the communication port 100[1, m]. The aggregation communication packet SP[p, 1, m] is transmitted from each of communication ports 100[1, m] to the distributed processing node 1a[2] assigned with a succeeding number, via the communication path 2[1, m] (step S104 in FIG. 5).

Next, each of communication units 10[1, m] of intermediate distributed processing nodes 1a[i] (i=2, . . . , N−1) previously determined from among the plurality of distributed processing nodes 1a[n], except the first and the N-th distributed processing nodes 1a[i], receives the aggregation communication packet SP[p, i−1, m] from each of the distributed processing nodes 1a[i−1] via the communication path 2[i−1, m] and the communication port 101[i, m], and acquires intermediate consolidated data Rtm[j, i−1] from the received aggregation communication packet SP[p, i−1, m] (step S105 in FIG. 5).

The consolidated data generation unit 19a in each of the distributed data generation units 11[1, m] of the distributed processing nodes 1a[1] calculates, for each corresponding weight w[j] (each number j) and for each group, the sum of the intermediate consolidated data Rtm[j, i−1] acquired by each of the corresponding communication units 10[i, m] and the distributed data D[j, 1] generated by the in-node consolidation processing unit 18a in each of the distributed data generation units 11[i, m], to generate intermediate consolidated data Rtm[j, i] for each group (step S106 in FIG. 5).

Subsequently, each of the communication units 10[i, m] of the distributed processing nodes 1a[i] packetizes the intermediate consolidated data Rtm[j, i] generated by the consolidated data generation unit 19a of each corresponding distributed data generation unit 11[i, m], and outputs the generated aggregation communication packet SP[p, i, m] (p=1, . . . , P) to the communication port 100[i, m]. The aggregation communication packet SP[p, i, m] is transmitted from each of the communication ports 100[1, m] to the distributed processing node 1a[i+1] assigned with a succeeding number, via the communication path 2[i, m] (step S107 in FIG. 5).

Each of communication units 10[N, m] of the N-th distributed processing node 1a[N] previously determined from among the plurality of distributed processing nodes 1a[n] receives the aggregation communication packet SP[p, N-1, m] from each of the distributed processing nodes 1a[N-1] via the communication path 2[N-1, m] and the communication port 101[N, m], and acquires intermediate consolidated data Rtm[j, N−1] from the received aggregation communication packet SP[p, N-1, m] (step S108 in FIG. 5).

The consolidated data generation unit 19a in each of the distributed data generation units 11[N, m] of the N-th distributed processing node 1a[N] calculates, for each corresponding weight w[j] (each number j) and for each group, the sum of the intermediate consolidated data Rtm[j, N-1] acquired by each of the corresponding communication units 10[N, m] and the distributed data D[j, N] generated by the in-node consolidation processing unit 18a in each of the distributed data generation units 11[N, m], to generate intermediate consolidated data Rtm[j, N] for each group (step S109 in FIG. 5).

Subsequently, each of the communication units 10[N, m] of the N-th distributed processing node 1a[N] packetizes the intermediate consolidated data Rtm[j, N] generated by the consolidated data generation unit 19a of each corresponding distributed data generation unit 11[N, m], and outputs the generated aggregation communication packet SP[p, N, m] to the communication port 100[N, m]. The aggregation communication packet SP[p, N, m] is transmitted from each of communication ports 100[N, m] to the first distributed processing node 1a[1], via the communication path 2[N, m] (step S110 in FIG. 5).

Next, dispatch communication is performed in which the intermediate consolidated data Rtm[j, N] is distributed as consolidated data Rm[j] to each of the distributed processing nodes 1a[n]. Each of the communication units 10[1, m] of the first distributed processing node 1a[1] receives the aggregation communication packet SP[p, N, m] from the distributed processing node 1a[N] via the communication path 2[N, m] and the communication port 101[1, m] of the first distributed processing node 1a[1], and acquires intermediate consolidated data Rtm[j, N] from the received aggregation communication packet SP[p, N, m] (step S111 in FIG. 5).

Each of the communication units 10[1, m] of the first distributed processing node 1a[1] defines the received intermediate consolidated data Rtm[j, N] as consolidated data Rm[j], packetizes the consolidated data Rm[j], and outputs the generated dispatch communication packet DP[p, 1, m] to the communication port 101[1, m] of the first distributed processing node 1a[1]. The dispatch communication packet DP[p, 1, m] is transmitted from each of the communication ports 101[1, m] to the N-th distributed processing node 1a[N], via the communication path 2[N, m] (step S112 in FIG. 5).

Subsequently, each communication unit 10[k, m] of the distributed processing nodes 1a[k] (k=N, . . . , 2) of the plurality of distributed processing nodes 1a[n], except the first distributed processing node 1a, receives the dispatch communication packet DP[p, k⁺, m] from a distributed processing node 1a[k⁺] (k⁺=k+1, provided that k⁺=1 if k=N) assigned with a succeeding number, via the communication path 2[k, m] and the communication port 100[k, m] of the distributed processing nodes 1a[k], and acquires consolidated data Rm[j] from the received dispatch communication packet DP[p, k+, m] (step S113 in FIG. 5).

Each of the communication units 10[k, m] of the distributed processing nodes 1a[k] packetizes the received consolidated data Rm[j] and outputs the generated dispatch communication packet DP[p, k, m] to the communication port 101[k, m] of the distributed processing node 1a[k]. The dispatch communication packet DP[p, k, m] is transmitted from each of the communication ports 101[k, m] to a distributed processing node 1a[k−1], via a communication path 2[k−1, m] (step S114 in FIG. 5).

Each of the communication units 10[1, m] of the first distributed processing node 1a[1] receives the dispatch communication packet DP[p, 2, m] from the distributed processing node 1a[2] via the communication path 2[1, m] and the communication port 100[1, m] of the first distributed processing node 1a[1], and acquires consolidated data Rm[j] from the received dispatch communication packet DP[p, 2, m] (step S115 in FIG. 5). An equation for calculating the consolidated data Rm[j] is as follows.

Rm[j]=Σ_{n=1, . . . ,N}D[j, N] . . . (8)

Furthermore, each of the distributed processing nodes 1a[n] transfers the acquired consolidated data Rm[j] from each of the communication units 10[n, m] via the internal communication path 12[n] to the distributed data generation unit 11[n, m]. Moreover, each of the distributed data generation units 11[n, m] of each of the distributed processing nodes 1a[n] performs an in-node dispatch process. In the in-node dispatch process, the consolidated data Rm[j] acquired by each of the distributed data generation units 11[n, m] is distributed, via the internal communication path 12[n], to another distributed data generation unit [n, m′] (m′=M, m′≠m) included in the distributed processing node 1a[n], so that all the distributed data generation units 11[n, m] included in the distributed processing node 1a[n] acquire all pieces of consolidated data Rm[j].

In the present embodiment, a flow of a weight updating process of the distributed processing node 1a[n] is similar to that in the first embodiment. When receiving the consolidated data Rm[j] (YES in step S122 of FIG. 8), the weight updating processing unit 20a in each of the distributed data generation units 11[n, m] of each of the distributed processing nodes 1a[n] performs a weight updating process of updating the weight w[j] of the neural network 21 in the distributed processing node 1a[n], based on the received consolidated data Rm[j] (step S123 in FIG. 8).

When one mini batch learning is terminated due to the termination of the weight updating process, each of the distributed processing nodes 1a[n] continuously performs the next mini batch learning process, based on the updated weight. That is, each of the distributed processing nodes 1a[n] receives sample data for the next mini batch learning from a data collecting node not illustrated in the drawing, and repeats the above-described mini batch learning process to improve the accuracy of inference of the neural network of the distributed processing node 1a[n].

As described above, the in-node consolidation process for calculating the distributed data D[j, n] (Equation (7)) is performed separately for each weight number j. Similarly, the aggregation communication process for calculating the consolidated data Rm[j] (Equation (8)) is also a combination of a process performed separately for each weight number j and simple data transmission/reception (communication of a numerical value performed separately for each weight number j). Furthermore, the weight updating process is also performed separately for each weight number j. Moreover, the transfer of distributed data D[j, n] from the distributed data generation unit 1[n, m] to the communication unit 10[n, m], the dispatch communication, the transfer of the consolidated data Rm[j] from the communication unit 10[n, m] to the distributed data generation unit 11[n, m], and the in-node dispatch process are simple data transfers (transfer of a numerical value performed separately for each weight number j) or data transmission/reception (communication of a numerical value performed separately for each weight number j), and thus, are processes performed separately for each weight number j.

Consequently, processes (the in-node consolidation process, the transfer of distributed data D[j, n] from the distributed data generation unit 11[n, m] to the communication unit 10[n, m], the aggregation communication process, the dispatch communication process, a transfer process of the consolidated data Rm[j] from the communication unit 10[n, m] to the distributed data generation unit 1[n, m], the in-node dispatch process, and the weight updating process) performed after the gradient calculation process for each piece of sample data is completed can be performed in a pipelined manner in units of weight numbers z.

Thus, it is possible to perform the processes from the in-node consolidation process to the weight updating process substantially simultaneously (in a pipelined process in units of numerical values). Consequently, a processing time can be significantly reduced, as compared with the known art in which the next process cannot be started until all communications and processes are completed. Note that the smallest unit of data transfer and data transmission/reception are generally per packet in which a plurality of numerical values are capsuled, and in such a system, processes are performed in a pipelined manner in units of packets.

In the present embodiment, similarly to the first embodiment, the distributed processing nodes are connected by the M communication paths 2[n, m] and the M communication units 10[n, m] included in each of the distributed processing nodes 1a[n] perform aggregation communication and dispatch communication. The aggregation communication and the dispatch communication are each parallelized in M, and thus, in the present embodiment, the amount of data transferred by each of the communication paths 2[n, m] and each of the communication units 10[n, m] can be reduced to 1/M, as compared to a distributed system in which the aggregation communication and the dispatch communication are performed by one communication unit included in each of the distributed processing nodes. As a result, in the present embodiment, it is possible to significantly reduce the time required for transferring data in a distributed processing system in which the time required for transferring data takes up a major part of the time needed for aggregation communication and dispatch communication.

In the present embodiment, the number of the distributed data generation units 11[n, m] included in each of the distributed processing nodes 1a[n] is equal to the number of the communication units 10[n, m], so that the gradient calculation process that typically has a large processing load is parallelized in M, and thus, it is possible to significantly reduce the time required for the deep learning process.

Furthermore, each of the distributed processing nodes 1a[n] performs a process in which each piece of data obtained by dividing the data amount into 1/M is transferred between the communication unit 10[n, m] and the corresponding distributed data generation unit 11[n, m] (data is transferred in M parallel processes). In this transfer process, different paths are used for each number m (for each group), so that even if all transfers are performed simultaneously, a deterioration of the transfer speed due to the shared use of paths does not occur.

Further, an example of the internal communication path 12[n] includes a communication path conforming to the PCI Express standard. Such an internal communication path 12[n] includes a switch for enabling data transfer between a plurality of devices (in the present embodiment, between the communication unit and the distributed data generation unit). Normally, the same switch is used in common in a data transfer after a data assigned with number m, but a transfer process within the switch is typically performed in a non-blocking manner (even if a plurality of transfers having different transfer sources and transfer destinations are simultaneously performed, it is guaranteed that the speed of each transfer does not deteriorate). Thus, a deterioration of the transfer speed due to the shared use of a switch does not occur.

In the present embodiment, the gradient calculation process, the aggregation communication process, and the dispatch communication process that take up a major part of the time needed for a deep learning process are parallelized in M to increase the speed of the deep learning process. Furthermore, in the present embodiment, all processes from the in-node consolidation process to the in-node dispatch process are parallelized in M, so that, when these processes are performed in a pipelined manner in units of weight numbers z, it is possible to prevent a limitation of the speed due to band restrictions of the data transfer within the node.

Note that, in the present embodiment, after the in-node dispatch process, the weight updating process for all of the weights w[z] is performed by each of the distributed data generation units 11[n, m]. If this order is reversed, it is possible to perform the processes including the weight updating process in M parallel processes. That is, after using the consolidated data Rm[j] (j=Z/M*(m−1)+1, . . . , Z/M*m) transferred from the communication unit 10[n, m] to update the weight w[j], the distributed data generation unit 11[n, m] distributes the updated weight w[j] to the other distributed data generation units [n, m′] (m′=1, . . . , M, m′*m). Thus, the number of weights handled by each of the distributed data generation units 1[n, m] in the weight updating process can be reduced to 1/M.

Each of the distributed processing nodes 1[n] and 1a[n] described in the first and second embodiments can be realized by a computer provided with a central processing unit (CPU), a storage device, and an interface, and a program controlling these hardware resources.

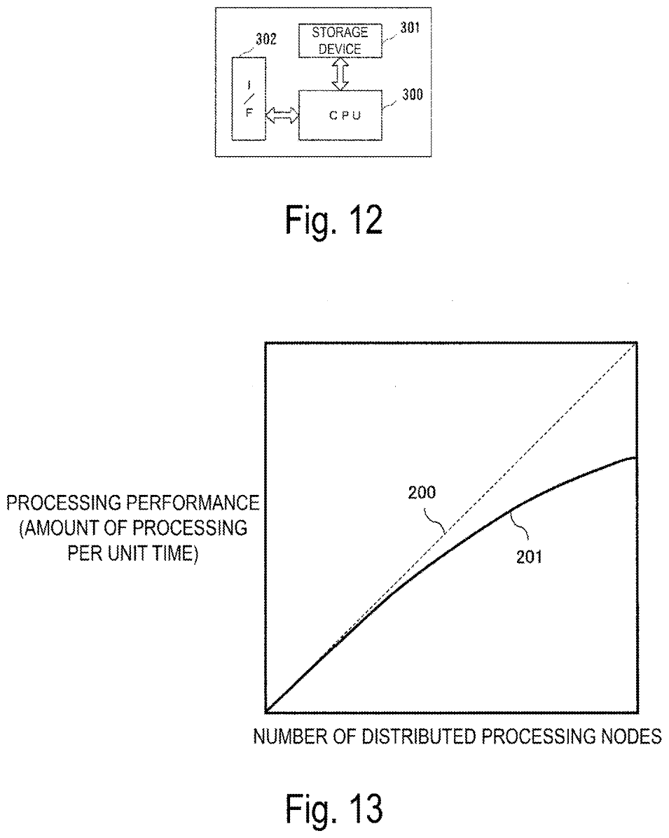

A configuration example of the computer is illustrated in FIG. 12. The computer includes a CPU 300, a storage device 301, and an interface device (hereinafter abbreviated as I/F) 302. For example, a communication circuit including communication ports 100 and 101 is connected to the I/F 302. The CPU 300 executes the processes described in the first and second embodiments in accordance with a program stored in the storage device 301, to realize the distributed processing system and the distributed processing method according to embodiments of the present disclosure.

### INDUSTRIAL APPLICABILITY

The embodiments of the present disclosure can be applied to techniques for performing machine learning of a neural network.

### REFERENCE SIGNS LIST

1, 1a . . . Distributed processing node

2 . . . Communication path

11 . . . Distributed data generation unit

12 . . . Internal communication path

16, 16a . . . Sample data input unit

17, 17a . . . Gradient calculation processing unit

18, 18a . . . In-node consolidation processing unit

19, 19a . . . Consolidated data generation unit

20, 20a . . . Weight updating processing unit

21, 21a . . . Neural network

22 . . . Data division unit

100, 101 . . . Communication port

1.-4. (canceled)

5. A distributed processing system comprising:
N (N being an integer equal to or greater than 2) distributed processing nodes arranged in a ring shape, each of the N distributed processing nodes being connected to an adjacent node via a communication path,
wherein:
an n-th (n=1, . . . , N) distributed processing node of the N distributed processing nodes comprises M (M being an integer equal to or greater than 2) communicators capable of simultaneous communication in both directions with an n⁺-th (n⁺=n+1, provided that n⁺=1 if n=N) distributed processing node of the N distributed processing nodes and an n⁻-th (n⁻=n−1, provided that n⁻=N if n=1) distributed processing node of the N distributed processing nodes,
each of the N distributed processing nodes is configured to generate pieces of distributed data for M groups, each of the M groups comprising an identical number of pieces of distributed data as the number of weights of a neural network that is a learning target,
a first distributed processing node previously determined from among the N distributed processing nodes is configured to define the pieces of distributed data for the M groups generated by the first distributed processing node as pieces of first consolidated data, and to transmit the pieces of first consolidated data from the corresponding communicator for each of the M groups of the first distributed processing node to a second distributed processing node of the N distributed processing nodes via the communication path for each of the M groups,
a k-th (k=2, . . . , N) distributed processing node of the N distributed processing nodes excluding the first distributed processing node is configured to calculate, for each of the weights and for each of the M groups, a sum of first consolidated data of the pieces of first consolidated data for each of the M groups received from a (k−1)-th distributed processing node of the N distributed processing nodes via the M communicators of the k-th distributed processing node and distributed data for each of the M groups generated by the k-th distributed processing node, to generate pieces of updated first consolidated data, and to transmit the pieces of updated first consolidated data from the corresponding communicator for each of the M groups of the k-th distributed processing node to a k⁺-th (k⁺=k+=1, provided that k⁺=1 if k=N) distributed processing node of the N distributed processing nodes via the communication path for each of the M groups,
the first distributed processing node is configured to define first consolidated data for each of the M groups received from an N-th distributed processing node of the N distributed processing nodes via the M communicators of the first distributed processing node as pieces of second consolidated data, and to transmit the pieces of second consolidated data from the corresponding communicator for each of the M groups of the first distributed processing node to the N-th distributed processing node via the communication path for each of the M groups,
the k-th distributed processing node is configured to transmit second consolidated data of the pieces of second consolidated data for each of the M groups received from the k⁺-th distributed processing node via the M communicators of the k-th distributed processing node, from the corresponding communicator for each of the M groups of the k-th distributed processing node to the (k−1)-th distributed processing node via the communication path for each of the M groups,
the first distributed processing node is configured to receive the second consolidated data from the second distributed processing node via the M communicators of the first distributed processing node, and
each of the N distributed processing nodes is configured to update the weights of the neural network, in accordance with the second consolidated data that is received.

6. The distributed processing system of claim 5, wherein each of the N distributed processing nodes comprises:
the M communicators;
an in-node consolidation processor configured to generate distributed data for each of the weights;
a data divider configured to divide distributed data generated by the in-node consolidation processor into the M groups;
a consolidated data generator configured to generate updated first consolidated data of the pieces of updated first consolidated data when each of the N distributed processing nodes operates as the k-th distributed processing node; and
a weight updating processor configured to update the weights of the neural network, in accordance with the second consolidated data that is received.

7. The distributed processing system of claim 5, wherein each of the N distributed processing nodes comprises:
the M communicators; and
M distributed data generators connected to the M communicators via corresponding internal communication paths,
wherein each of the M distributed data generators comprises:
an in-node consolidation processor configured to generate the distributed data for each of the M groups;
a consolidated data generator configured to generate the updated first consolidated data for each of the M groups when each of the N distributed processing nodes operates as the k-th distributed processing node; and
a weight updating processor configured to update the weights of the neural network, in accordance with the second consolidated data that is received,
wherein each of the M distributed data generators is configured to transfer the distributed data for each of the M groups to the corresponding communicators via the corresponding internal communication paths, and
wherein each of the M communicators is configured to transfer the first consolidated data and the second consolidated data for each of the M groups to corresponding distributed data generator of the M distributed data generators via the corresponding internal communication paths.

8. A distributed processing method for a system, the system comprising N (N being an integer equal to or greater than 2) distributed processing nodes arranged in a ring shape, each of the N distributed processing nodes being connected to an adjacent node via a communication path, an n-th (n=1, . . . , N) distributed processing node of the N distributed processing nodes comprising M (M being an integer equal to or greater than 2) communicators capable of simultaneous communication in both directions with an n⁺-th (n⁺=n+1, provided that n⁺=1 if n=N) distributed processing node of the N distributed processing nodes and an n-th (n⁻=n−1, provided that n⁻=N if n=1) distributed processing node of the N distributed processing nodes, the distributed processing method comprising:
generating, by each of the N distributed processing nodes, pieces of distributed data for M groups, each of the M groups comprising an identical number of pieces of distributed data as the number of weights of a neural network that is a learning target;
defining, by a first distributed processing node previously determined from among the N distributed processing nodes, the pieces of distributed data for the M groups generated by the first distributed processing node as pieces of first consolidated data, and transmitting the pieces of first consolidated data from the corresponding communicator for each of the M groups of the first distributed processing node to a second distributed processing node of the N distributed processing nodes via the communication path for each of the M groups;
calculating, by a k-th (k=2, . . . , N) distributed processing node of the N distributed processing nodes excluding the first distributed processing node, for each of the weights and for each of the M groups, a sum of first consolidated data of the pieces of first consolidated data for each of the M groups received from a (k−1)-th distributed processing node of the N distributed processing nodes via the M communicators of the k-th distributed processing node and distributed data for each of the M groups generated by the k-th distributed processing node, to generate pieces of updated first consolidated data, and transmitting the pieces of updated first consolidated data from the corresponding communicator for each of the M groups of the k-th distributed processing node to a k⁺-th (k⁺=k+1, provided that k⁺=1 if k=N) distributed processing node of the N distributed processing nodes via the communication path for each of the M groups;
defining, by the first distributed processing node, first consolidated data for each of the M groups received from an N-th distributed processing node of the N distributed processing nodes via the M communicators of the first distributed processing node as pieces of second consolidated data, and transmitting the pieces of second consolidated data from the corresponding communicator for each of the M groups of the first distributed processing node to the N-th distributed processing node via the communication path for each of the M groups;
transmitting, by the k-th distributed processing node, second consolidated data of the pieces of second consolidated data for each of the M groups received from the k⁺-th distributed processing node via the M communicators of the k-th distributed processing node, from the corresponding communicator for each of the M groups of the k-th distributed processing node to the (k−1)-th distributed processing node via the communication path for each of the M groups;
receiving, by the first distributed processing node, the second consolidated data from the second distributed processing node via the M communicators of the first distributed processing node; and
updating, by each of the N distributed processing nodes, the weights of the neural network, in accordance with the second consolidated data that is received.
